(19) United States
(12) Patent Application Publication
(10) Pub. No.: US 2009/0218382 A1
(43) Pub. Date: Sep. 3, 2009

(54) Sheathing device for the staple channel of stapler

(76) Inventor: Chun-Yuan Chang, Taipei (TW)

Correspondence Address: Chun-Yuan Chang, P.O. Box 44 - 2049, Taipei, 10668, TW

(21) Appl. No.: 12/071,939

(22) Filed: Feb. 28, 2008

(51) Int. Cl. B27F 7/00

(52) U.S. Cl. 227/119

(57) ABSTRACT

The present invention provides a sheathing device for the staple channel of stapler, and more particularly to one which could provide sufficient protection for the staple channel of powerful stapler under continuous strong friction and impact force of the rivet; it is mainly characterized in that, a U-shaped depressed zone is formed within the staple channel of the stapler, and a U-shaped steel sheet is embedded correspondingly; with direct contact of U-shaped steel sheet and the rivet, it is possible to prevent efficiently rupture of the main body of the stapler and poorer stapling performance arising from impact force and friction.

### BACKGROUND OF THE INVENTION

(1) Field of the Invention

The present invention relates generally to a sheathing device for the staple channel of stapler, and more particularly to an innovative one which permits a U-shaped steel sheet to be embedded into the staple channel for direct contact with the rivet, thus providing protection against any possible impact and rupture of the main body and preventing frictional loss with the rivet for maintaining an optimum state of the stapler.

(2) Description of the Prior Art

The powerful spring or spring chip of stapling nail is connected with a shiftable rivet to generate strong impact force, so that the rivet is released to make the stapler yield a strong stapling action, thus eliminating the traditional stapling through manual press-down. However, at least the following shortcomings for such stapler with strong impact force are observed from actual applications:

One: the rivet could finish the stapling of dozens of sheets under the instantaneous press-down of powerful spring or spring chip, so the main body of the staple channel, especially its head, must withstand the strong impact force and counterforce; once the impact reaches a certain amount, a rupture would occur at the staple channel, leading to abandonment of entire stapler.

Two: with continuous rise or decline of the rivet, friction phenomenon would occur between the rivet and the plastic main body of the staple channel, so the staple channel would be worn quickly with a growing gap, and the stapling nails cannot be adapted to mate with the staple channel; the declining rivet cannot be aligned with the stapling nail, leading to poorer stapling phenomenon with the increase of stapling action.

### SUMMARY OF THE INVENTION

To this end, the inventor has provided an improved stapler after deliberate research and modification. The major purpose is to provide an effective protection of staple channel against the impact force generated by the strong rivet, thereby extending greatly the service life of the stapler.

The other purpose of the present invention is to prevent the wear abrasion of staple channel through assembly of a U-shaped steel sheet, thus ensuring the stapling performance and maintaining the optimum state of the stapler.

### BRIEF DESCRIPTION OF THE DRAWINGS

FIG. 1 shows a partially sectional view of the stapler of the present invention.

FIG. 2 shows a configuration view of the bottom of the main body of stapler of the present invention.

FIG. 3 shows a configuration view of U-shaped steel sheet at bottom of the main body of stapler.

### DETAILED DESCRIPTION OF THE PREFERRED EMBODIMENTS

The structural composition and technical efficacy of the present invention are described below with reference to the preferred embodiments:

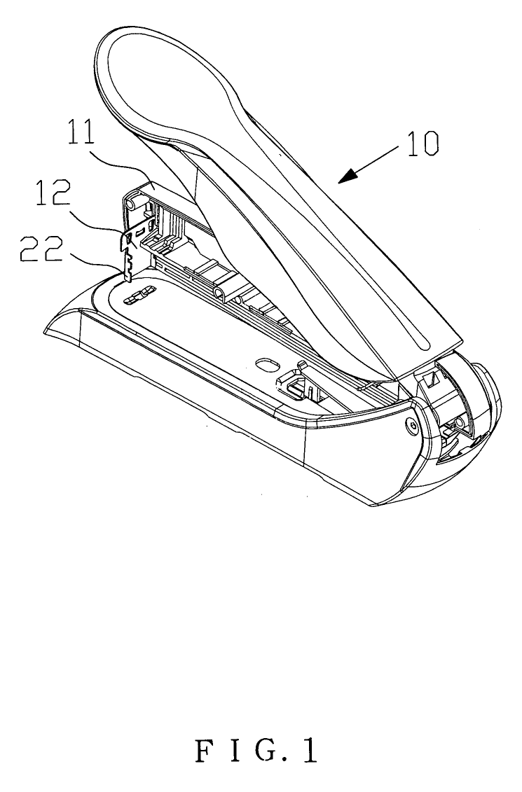

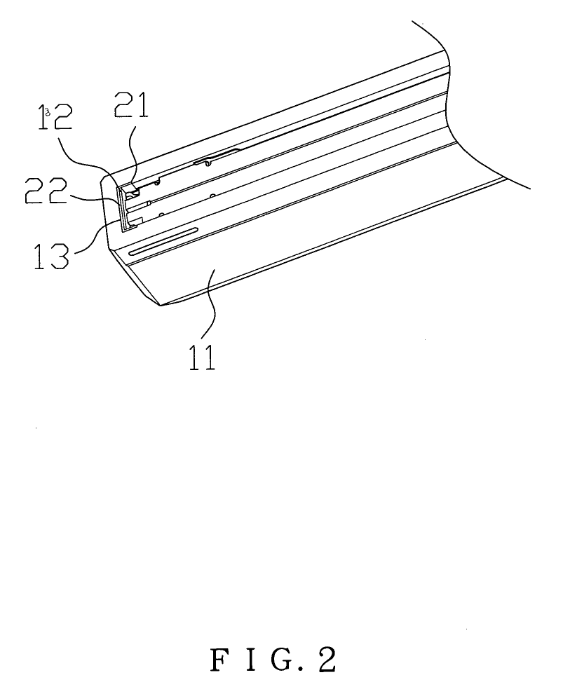

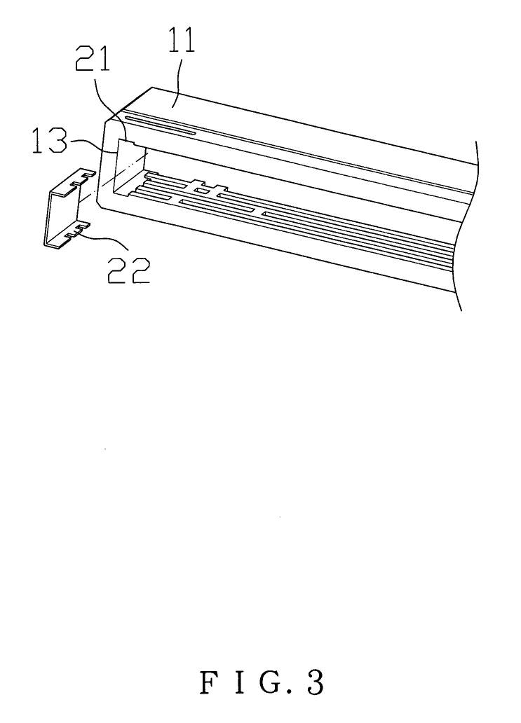

FIG. 2 depicts a configuration view of the bottom of the main body of stapler, and FIG. 3 depicts a configuration view of U-shaped steel sheet at bottom of the main body of stapler. Referring to FIG. 1, the stapler 10 of the present invention is a stapling machine which is provided with a strong spring chip within the coated main body 11. The front end of the spring chip hooks onto the rivet 12, so that when the rivet 12 is pulled to a certain height and released, the rivet 12 is pressed down instantaneously to strike the stapling nail for stapling of dozens of sheets with strong counterforce of the spring chip.

As the impact force of the rivet 12 must generate a strong force for the stapler to penetrate through dozens of sheets, the instantaneous impact force and counterforce would lead to continuous impact against the main body 11. Therefore, a specific depressed zone 21 is formed at inner side of the staple channel, where a steel sheet or a U-shaped steel sheet 22 made of wear resistant materials is embedded, so that it is located between the movable position of rivet 12 of the staple channel within the main body 11 (shown in FIG. 2), and fully covered onto the rivet 12.

With embedding of U-shaped steel sheet 22, it is also possible to prevent frictional loss of the rivet within the head of the main body 11 and protect efficiently this region against any impact force, thus avoiding any rupture (shown in FIG. 3).

Referring also to FIG. 2, the rivet 12 shifts up and down in close contact with the inner wall of staple channel 13 of the main body 11; during continuous and rapid impact process, the metal rivet 12 would generate frictional loss of the plastic inner wall 13, leading to growing gap and poorer stapling. In such case, this phenomenon could be improved to maintain an outstanding stapling performance by embedding a U-shaped steel sheet 22 in the region shown in FIG. 3.

Thus, with the use of U-shaped steel sheet 22 assembled within the staple channel at head of the main body, it is possible to protect the stapler against powerful impact force, and prevent the rupture of the head of the main body of the stapler for maintaining the good stapling performance.

What is claimed is:

1. A sheathing device for the staple channel of stapler, which permits a specific depressed zone to be formed within the staple channel at head of the main body of the stapler, where a U-shaped steel sheet is embedded to cover and attach onto the rivet.

2. The device defined in claim 1, wherein U-shaped steel sheet is made of other wear resistant materials.
